(19) United States
(12) Patent Application Publication
(10) Pub. No.: US 2021/0143724 A1
(43) Pub. Date: May 13, 2021

(54) Automatic Fuel Energy Generated Car

(71) Applicants: ARPIT JAIN, U.P. (IN); Vineet Tirth, Asir (SA); Ali Algahtani, Asir (SA); Shakti Kundu, Up (IN); S.B. Chordiya, Pune (IN); Yogesh Mohanrao Nigade, Pune (IN); Abhijit Prakash Bhujbal, Pune (IN); Dhanke Jyoti Atul, Pune (IN); Beg Raj, Mirzapur (IN); B.K. Sarkar, Pune (IN)

(72) Inventors: ARPIT JAIN, U.P. (IN); Vineet Tirth, Asir (SA); Ali Algahtani, Asir (SA); Shakti Kundu, Up (IN); S.B. Chordiya, Pune (IN); Yogesh Mohanrao Nigade, Pune (IN); Abhijit Prakash Bhujbal, Pune (IN); Dhanke Jyoti Atul, Pune (IN); Beg Raj, Mirzapur (IN); B.K. Sarkar, Pune (IN)

(21) Appl. No.: 17/146,631

(22) Filed: Jan. 12, 2021

(51) Int. Cl. H02K 53/00; H02J 7/35; B60L 53/51; B60L 53/52; F03D 9/25; F03D 1/04; F03D 9/32

(52) U.S. Cl. CPC H02K 53/00; H02J 7/35; B60L 53/51; B60L 53/52; F03D 9/25; F41B 6/006; F03D 9/32; F05B 2220/708; F05B 2220/706; F05B 2260/42; F03D 1/04

(57) ABSTRACT

Our Invention “Automatic Fuel Energy Generated Car” is a concept used to generate adequate electrical power to charge a plurality of storage batteries driving a perpetual, fuel-free electric vehicle or alike. The batteries supply adequate power to at least one electric motor to propel the vehicle and supply electricity to all other vehicle instruments such as lights, wipers, defogger, etc. The invented technology also includes the two alternatives, and green energy sources are used to continuously charge the batteries: solar energy generated from solar panels covering every and all possible area of the vehicle's exterior surface and wind energy generated by one or more electric generators driven by one or more wind turbines mounted within the vehicle and placed under its exterior surface. The invented technology is a front, top and side wind streams surrounding the vehicle, are channeled through air passages and each air passage is designed as a funnel-like air duct where the end of the air duct with the smaller cross-sectional area is directed into the entry of the wind turbine system to accelerate the streamlined winds. The energy of the aggregated and accelerated winds harnessed by one or more wind turbine systems placed in the wind streams' path. Each wind turbine system has an electric generator to convert the rotational energy of turbine's shaft into electric energy. The invented technology takes the output of each wind turbine generator to a controller unit where electric voltage is regulated and converted, if necessary, to charge the plurality of storage batteries. The output of the solar panels are also applied to the controller unit to be regulated and converted if necessary to charge storage batteries' plurality. The controller unit continuously charges the batteries of the electric vehicle, whether the vehicle is stopped or running. The controller unit is also connected to an external, stand-by power supply unit used only to charge the batteries under unexpected circumstances such as system failure.

### FIELD OF THE INVENTION

Our invention “Automatic Fuel Energy Generated Car” is related to an electric car, which should generate the car fuel energy from the sun with positive and negative signals and generate the power to run a vehicle. The invention also relates to vehicles operated by electric motors relying on a set of batteries as a stored energy source, in which the batteries are recharged, powering the electric motors by solar and wind sustainable energy sources.

### BACKGROUND OF THE INVENTION

The power generation and, in particular, to systems, devices, and methods for the generation of power. More specifically, embodiments of the present disclosure are directed to power generation devices and systems, as well as related methods, which produce optical power, plasma, and thermal power and produces electrical power via an optical to the electric power converter, plasma to the electric power converter, photon to the electric power converter, or a thermal to the electric power converter, besides, embodiments of the present disclosure describe systems, devices, and methods that use the ignition of water or water-based fuel source to generate optical power, mechanical power, electrical power, and/or thermal power using photovoltaic power converters. These and other related embodiments are described in detail in the present disclosure.

Power generation can take many forms including harnessing the power from plasma. Successful commercialization of plasma may depend on power generation systems capable of efficiently forming plasma and then capturing the power of the plasma produced. Plasma may be formed during the ignition of specific fuels. These fuels can include water or water-based fuel source. A plasma cloud of electron-stripped atoms is formed during ignition, and high optical power may be released. This high optical power of the plasma can be harnessed by an electric converter of the present disclosure. The ions and excited-state atoms can recombine and undergo electronic relaxation to emit optical power. The optical power can be converted to electricity using photovoltaic*.

Certain embodiments of the present disclosure are directed to a power generation system comprising: a plurality of electrodes configured to deliver power to fuel to ignite it and produce a plasma; a source of electrical power configured to deliver electrical energy to the plurality of electrodes, and at least one photovoltaic power converter positioned to receive a plurality of plasma photons. In one embodiment, the present disclosure is directed to a power system that generates at least one of electrical energy and thermal energy comprising at least one vessel capable of withstanding the pressure below atmospheric; shot comprising reactants, and the reactants comprising:

1. At least one source of catalyst or a catalyst comprising nascent H₂O;
2. At least one source of H₂O;
3. At least one source of atomic hydrogen; and
4. At least one conductor and a conductive matrix;

One shot injection system comprising at least one augmented railgun, wherein the augmented railgun comprises separated electrified rails and magnets that produce a magnetic field perpendicular to the plane of the rails, and the circuit between the rails is open until closed by the contact of the shot with the rails; at least one ignition system to cause the shot to form at least one of light-emitting plasma and thermal-emitting plasma, at least one ignition system comprising:

1. One set of electrodes to confine the shot; and
2. A source of electrical power to deliver a short burst of high-current electrical energy:
wherein at least one set of electrodes from an open circuit, wherein the open circuit is closed by the injection of the shot to cause the high current to flow to achieve ignition, and the source of electrical power to deliver a short burst of high-current electrical energy comprises at least one of the following:

A voltage selected to cause a high AC, DC1 o an AC-DC mixture of current that is in the range of one of the following; 100 A to 1,000,000 A, 1 kA to 100,000 A, 10 kA to 50 kA; a DC or peak AC current density in the range of at least one of 100 A/cm2 to 1,000,000 A/cm2, 000 A/cm2 to 100,000 A/cm2, and 2000 A/cm2 to 50,000 A/cm2; the voltage is determined by the conductivity of the solid fuel or energetic material wherein the voltage is given by the desired current times the resistance of the solid fuel or energetic material sample; the DC or peak AC voltage is in the range of at least one of 0. f V to 500 kV, 0.1 V to 100 kV, and 1 V to 50 kV, and the AC frequency is in range of at least one of 0.1 Hz to 10 GHz, 1 Hz to 1 MHz, 10 Hz to 100 kHz, and 100 Hz to 10 id-fa.

A system to recover reaction products of the reactants comprising at least one of gravity and an augmented plasma railgun recovery system comprising at least one magnet providing a magnetic field and a vector-crossed current component of the ignition electrodes; at least one regeneration system to regenerate additional reactants from the reaction products and from additional shot comprising a pelletizer comprising a smelter to form molten reactants, a system to add H2 and H2O to the molten reactants, a melt dripper, and a water reservoir to form shot, wherein the additional reactants comprise:

1. At least one source of catalyst or a catalyst comprising nascent H2O; b) at least one source of H2O or H2O;
2. At least one source of atomic hydrogen or atomic hydrogen;
3. At least one of a conductor and a conductive matrix;

At least one power converter or output system of at least one of the light and thermal output to electrical power and/or thermal power comprising at least one or more of the group of a photovoltaic converter, a photo electronic converter, a dynamic plasma converter, a thermionic converter, a thermoelectric converter, a Sterling engine, a Brayton cycle engine, a Rankine cycle engine, a heat engine, and a heater. In another embodiment, the present disclosure is directed to a power system that generates at least one of electrical energy and thermal energy comprising: at least one vessel capable of a pressure of below atmospheric; shot comprising reactants, the reactants comprising at least one of silver, copper, absorbed hydrogen, and water; at least one shot injection system comprising at least one augmented railgun wherein the augmented railgun comprises separated electrified rails and magnets that produce a magnetic field perpendicular to the plane of the rails, and the circuit between the rails is open until closed by the contact of the shot with the rails; at least one ignition system to cause the shot to form at least one of light-emitting plasma and thermal-emitting plasma, at least one ignition system comprising:

1. At least one set of electrodes to confine the shot; and
2. A source of electrical power to deliver a short burst of high-current electrical energy;
wherein at least one set of electrodes are separated to form an open circuit, wherein the open circuit is closed by the injection of the shot to cause the high current to flow to achieve ignition, and the source of electrical power to deliver a short burst of high-current electrical energy comprises at least one of the following:

A voltage selected to cause a high AC, DC, or an AC-DC mixture of current that is in the range of at least one of 100 A to 1,000,000 A, 1 kA to 100,000 A, 10 kA to 50 kA: a DC or peak AC current density in the range of at least one of 100 A/cm2 to 1,000,000 A/cm2, 1000 A/cm2 to 100,000 A/cm2, and 2000 A/cm2 to 50,000 A/cm2; the voltage is determined by the conductivity of the solid fuel or energetic material! wherein the voltage is given by the desired current times the resistance of the solid fuel or energetic material sample; the DC or peak AC voltage is in the range of at least one of 0.1 V to 500 kV, 0.1 V to 100 kV, and 1 V to 50 kV, and the AC frequency is in range of at least one of 0.1 Hz to 10 GHz, 1 H to 1 MHz, 10 Hz to 100 kHz, and 100 Hz to 10 kHz, a system to recover reaction products of the reactants comprising at least one of gravity and a augmented plasma railgun recovery system.

The comprising at least one magnet providing a magnetic field and a vector-crossed current component of the ignition electrodes; at least one regeneration system to regenerate additional reactants from the reaction products and form additional shot comprising a pelletizer comprising a smelter to form molten reactants, a system to add H2 and H2O to the molten reactants, a melt dripper, and a water reservoir to form shot, wherein the additional reactants comprise at least one of silver, copper, absorbed hydrogen, and water; at least one power converter or output system comprising a concentrator ultraviolet photovoltaic converter wherein the photovoltaic cells comprise at least one compound chosen from a Group Ml nitride, GaAlN, GaN, and InGaN. In another embodiment, the present disclosure is directed to a power system that generates at least one of electrical energy and thermal energy comprising:

At least one vessel; shot comprising reactants, the reactants comprising:

1. At least one source of catalyst or a catalyst comprising nascent H2O;
2. At least one source of H2O or H2O;
3. At least one source of atomic hydrogen or atomic hydrogen; and
4. At least one of a conductor and a conductive matrix;

At least one shot injection system; at least one shot ignition system to cause the shot to form at least one of light-emitting plasma and thermal-emitting plasma; a system to recover reaction products of the reactants; at least one regeneration system to regenerate additional reactants from the reaction products and form additional shot, wherein the additional reactants comprise:

1. At least one source of catalyst or a catalyst comprising nascent ¾ ( );
2. At least one source of H₂O or H₂O;
3. At least one source of atomic hydrogen or atomic hydrogen;
4. At least one of a conductor and a conductive matrix;

At least one power converter or output system of at least one light and thermal output to electrical power and/or thermal power. In another embodiment, the present disclosure is directed to a power system that generates at least one electrical energy and thermal energy comprising: at least one vessel; slurry comprising reactants. The reactants comprising:

1. At least one source of catalyst or a catalyst comprising nascent H₂O;
2. At least one source of H₂O;
3. At least one source of atomic hydrogen;
4. At least one of a conductor and a conductive matrix;
5. At least one slurry injection system comprising rotating roller electrodes comprising a rotary slurry pump;
6. At least one slurry ignition system to cause the shot to form a light-emitting plasma;
7. A system to recover reaction products of the reactants;

At least one regeneration system to regenerate additional reactants from the reaction products and form an additional slurry, wherein the additional reactants comprise:

1. At least one source of catalyst or a catalyst comprising nascent H₂O:
2. At least one source of H₂O or H₂O;
3. At least one source of atomic hydrogen or atomic hydrogen;
4. At least one of a conductor and a. conductive matrix;

At least one power converter or output system of at least one light and thermal output to electrical power and/or thermal power. Certain embodiments of the present disclosure are directed to a power generation system comprising: a plurality of electrodes configured to deliver fuel to ignite the fuel! and produce a plasma, a source of electrical power configured to deliver electrical energy to the plurality of electrodes. At least one photovoltaic power converter is positioned to receive at least a plurality of plasma photons. In one embodiment, the present disclosure is directed to a power system that generates at least one of direct electrical energy and thermal energy comprising: at least one vessel; reactants comprising:

1. At least one source of catalyst or a catalyst comprising nascent H₂O;
2. At least one source of atomic hydrogen or atomic hydrogen;
3. At least one of a conductor and a conductive matrix; and

At least one set of electrodes to confine the hydrino reactants, a source of electrical power to deliver a short burst of high-current electrical energy; a reloading system; at least one system to regenerate the initial reactants from the reaction products, and at least one plasma dynamic converter or at least one photovoltaic converter. In one exemplary embodiment, a method of producing electrical power may comprise supplying fuel to a region between a plurality of electrodes; energizing the plurality of electrodes to ignite the fuel to form a plasma; converting a plurality of plasma photons into electrical power with a photovoltaic power converter, and outputting at least a portion of the electrical power.

In another exemplary embodiment, a method of producing electrical power may comprise supplying fuel to a region between a plurality of electrodes: energizing the plurality of electrodes to ignite the fuel to form a plasma; converting a plurality of plasma photons into thermal power with a photovoltaic power converter, and outputting at least a portion of the electrical power.

In an embodiment of the present disclosure, a method of generating power may comprise delivering an amount of fuel to a fuel loading region, wherein the fuel loading region is located among a plurality of electrodes; igniting the fuel by flowing a current of at least about 2,000 A/cm2 through the fuel by applying the current to the plurality of electrodes to produce at least one of plasma, light, and heat; receiving at least a portion of the light in a photovoltaic power converter; converting the light to a different form of power using the photovoltaic power converter, and outputting the different form of power.

In an additional embodiment, the present disclosure is directed to a water arc plasma power system comprising: at least one closed reaction vessel; reactants comprising at least one source of H2O and H2O; at least one set of electrodes; a source of electrical power to deliver an initial high breakdown voltage of the H2O and provide a subsequent high current, and a heat exchanger system, wherein the power system generates arc plasma, light, and thermal energy, and at least one photovoltaic power converter.

Certain embodiments of the present disclosure are directed to a power generation system comprising: an electrical power source of at least about 2,000 A cm2 or of at least about 5,000 kW; a plurality of electrodes; electrically coupled to the electrical power source; a fuel loading region configured to receive a solid fuel, wherein the plurality of electrodes is configured to deliver electrical power to the solid fuel to produce a plasma; and at least one of a plasma power converter, a photovoltaic power converter, and term 1 to electric powers converter positioned to receive at least a portion of the plasma, photons, and/or heat generated by the reaction. Other embodiments are directed to a power generation system, comprising.

### A Plurality of Electrodes:

1. A fuel loading region located between the plurality of electrodes and configured to receive a conductive fuel, wherein the plurality of electrodes is configured to apply a current to the conductive fuel sufficient to ignite the conductive fuel and generate at least one of plasma and thermal power.
2. A delivery mechanism for moving the conductive fuel into the fuel-loading region.
3. At least one of a photovoltaic power converter to convert the plasma photons Into a form of power, or a thermal to the electric converter to convert the thermal power into a no thermal form of power comprising electricity or mechanical power.

Further embodiments are directed to a method of generating power, comprising: delivering an amount of fuel to a fuel loading region, wherein the fuel loading region is located among a plurality of electrodes; igniting the fuel by flowing a current of at least about 2,000 A/cm2 through the fuel by applying the current to the plurality of electrodes to produce at least one of plasma, light, and heat; receiving at least a portion of the light in a photovoltaic power converter; converting the light to a different form of power using the photovoltaic power converter; and outputting the different form of power.

Additional embodiments are directed to a power generation system, comprising: an electrical power source of at least about 5,000 kW; a plurality of spaced-apart electrodes, wherein the plurality of electrodes at least partially surround a fuel, are electrically connected to the electrical powers source, is configured to receive a current to ignite the fuel, and at least one of the plurality of electrodes Is moveable; a delivery mechanism for moving the fuel; and a photovoltaic power converter configured to convert plasma generated from the ignition of the fuel into a non-plasma form of power.

Additionally provided in the present disclosure is a power generation system, comprising: an electrical power source of at least about 2,000 A/cnr; a plurality of spaced-apart electrodes, wherein the plurality of electrodes at least; partially surround a fuel, are electrically connected to the electrical power source, are configured to receive a current to ignite the fuel, and at least one of the plurality of electrodes is moveable; a delivery mechanism for moving the fuel; and a photovoltaic power converter configured to convert plasma generated from the ignition of the fuel into a non-plasma form of power.

Another embodiment is directed to a power generation system, comprising: an electrical power source of at least about 5,000 kW or of at least about 2,000 A/cm2: a plurality of spaced-apart electrodes, wherein at least one of the plurality of electrodes includes a compression mechanism; a fuel loading region configured to receive fuel, wherein the fuel loading region is surrounded by the plurality of electrodes so that the compression mechanism of the at least one electrode is oriented towards the fuel loading region, and wherein the plurality of electrodes are electrically connected to the electrical power source and configured to supply power to the fuel received in the fuel loading region to ignite the fuel; a delivery mechanism for moving the fuel into the fuel loading region; and a photovoltaic power converter configured to convert photons generated from the ignition of the fuel into a non-photon form of power.

Other embodiments of the present disclosure are directed to a power generation system, comprising: an electrical power source of at least about 2,000 A/cm2; a plurality of spaced-apart electrodes, wherein at least one of the plurality of electrodes includes a compression mechanism; a fuel loading region configured to receive a fuel wherein the fuel loading region is surrounded by the plurality of electrodes so that the compression mechanism of the at least one electrode is oriented towards the fuel loading region, and wherein the plurality of electrodes are electrically connected to the electrical power source and configured to supply power to the fuel received in the fuel loading region to ignite the fuel; a delivery mechanism for moving the fuel into the fuel loading region; and a plasma power converter configured to convert plasma generated from the ignition of the fuel into a non-plasma form of power.

of the present disclosure are also directed to the power generation system, comprising: a plurality of electrodes; a fuel loading region surrounded by the plurality of electrodes and configured to receive fuel, wherein the plurality of electrodes is configured to ignite the fuel located in the fuel loading region; a delivery mechanism for moving the fuel into the fuel loading region; a photovoltaic power converter configured to convert photons generated from the ignition of the fuel into a non-p oton form of power; a removal system for removing a byproduct of the ignited fuel; and a regeneration system operably coupled to the removal system for recycling the removed byproduct of the ignited fuel into recycled fuel.

Certain embodiments of the present disclosure are also directed to a power generation system, comprising: an electrical power source configured to output a current of at least about 2,000 A/cm2 or of at least about 5,000 kW; a plurality of spaced-apart electrodes electrically connected to the electrical power source; a fuel loading region configured to receive fuel, wherein the fuel loading region is surrounded by the plurality of electrodes, and wherein the plurality of electrodes is configured to supply power to the fuel to ignite the fuel when received in the fuel loading region.

A delivery mechanism for moving the fuel into the fuel loading region; and a photovoltaic power converter configured to convert a plurality of photons generated from the ignition of the fuel into a non-photon form of power. Certain embodiments may further include one or more output power terminals operably coupled to the photovoltaic power converter; a power storage device; a sensor configured to measure at least one parameter associated with the power generation system, and a controller configured to control at least a process associated with the power generation system.

Certain embodiments of the present disclosure are also directed to a power generation system, comprising: an electrical power source, configured to output a current of at least about 2,000 A/cm2 or of at least about 5,000 kW; a plurality of spaced-apart electrodes, wherein the plurality of electrodes at least partially surround a fuel, is electrically connected to the electrical power source, are configured to receive a current to ignite the fuel, and at least one of the plurality of electrodes is moveable: a delivery mechanism for moving the fuel; and a photovoltaic power converter configured to convert photons generated from the ignition of the fuel into a different form of power.

Additional embodiments of the present disclosure are directed to a power generation system, comprising an electrical power source of at least 5,000 kW or at least about 2,000 A/cm2. A plurality of spaced-apart electrodes electrically connected to the electrical power source; a fuel loading region configured to receive fuel, wherein the plurality of electrodes surrounds the fuel loading region, and wherein the plurality of electrodes is configured to supply power to the fuel to ignite the fuel when received in the fuel loading region; a delivery mechanism for moving the fuel into the fuel loading region; a photovoltaic power converter configured to convert a plurality of photons generated from the ignition of the fuel into a non-photon form of power; a sensor configured to measure at least one parameter associated with the power generation system: and a controller configured to control at least a process associated with the power generation system. Further embodiments are directed to a power generation system, comprising: an electrical power source of at least about 2,000 A/cm2; a plurality of spaced-apart electrodes electrically connected to the electrical power source.

A fuel loading region configured to receive fuel, wherein the plurality of electrodes surrounds the fuel loading region, and wherein the plurality of electrodes is configured to supply power to the fuel to ignite the fuel when received in the fuel loading region; a delivery mechanism for moving the fuel into the fuel loading region; a plasma power converter configured to convert plasma generated front the ignition of the fuel into a non-plasma form of power; a sensor configured to measure at least one parameter associated with the power generation system, and a controller configured to control at least a process associated with the power generation system.

Certain embodiments of the present disclosure are directed to a power generation system, comprising: an electrical power source of at least about 5,000 kW or of at least about 2,000 A/cm2; a plurality of spaced-apart electrodes electrically connected to the electrical power source; a fuel loading region configured to receive fuel, wherein the plurality of electrodes surrounds the fuel loading region, and wherein the plurality of electrodes is configured to supply power to the fuel to ignite the fuel when received in the fuel loading region, and wherein a pressure in the fuel loading region is a partial vacuum; a delivery mechanism for moving the fuel into the fuel loading region: and a photovoltaic power converter configured to convert plasma generated from the ignition of the fuel into a non-plasma form of power.

Some embodiments may include one or more of the following additional features: the photovoltaic power converter may be located within a vacuum cell; the photovoltaic power converter may include at least one of an antireflection coating, an optical impedance matching coating, or a protective coating; the photovoltaic power converter may be operably coupled to a cleaning system configured to clean at least a portion of the photovoltaic power converter; the power generation system may include an optical filter; the photovoltaic power converter may comprise at least one of a monocrystalline cell, a polycrystalline cell, an amorphous 1ell, a string/ribbon silicon cell, a multi-junctional, a home-junctional, a heterojunction cell, a p-i-η device, a thin-film cell, a dye-sensitized cell, and an organic photovoltaic cell; and the photovoltaic power converter may comprise at multi-junctional, wherein the multi-junction cell comprises at least one of an inverted cell, an upright cell, a lattice-mismatched cell, a lattice-matched cell, and a cell comprising Group III-V semiconductor materials.

Additional exemplary embodiments are directed to a system configured to produce power, comprising: a fuel supply configured to supply a fuel; a power supply configured to supply an electrical power; and at least one gear configured to receive the fuel and the electrical power, wherein the at least one gear selectively directs the electrical power to a local region about the gear to ignite the fuel within the local region, in some embodiments, the system may further have one or more of the following features: the fuel may include a powder; the at least one gear may include two gears: the at least one gear may include a first material and a second material having a lower conductivity than the first material, the first material being electrically coupled to the local region, and the local region may be adjacent to at least one of a tooth and a gap of the at least one gear.

Other embodiments may use a support member in place of gear, while other embodiments may use the gear and a support member. Some embodiments are directed to a method of producing electrical power, comprising: supplying fuel to rollers or a gear; rotating the rollers or gear to localize at least some of the fuel at a region of the rollers or gear; supplying a current to the roller or gear to ignite the localized fuel to produce energy; and converting at least some of the energy produced by the ignition into electrical power, in some embodiments, rotating the rollers or gear may include rotating a first roller or gear and a roller or second gear, and supplying a current may include supplying a current to the first roller to gear and the roller or second gear.

Other embodiments are directed to a power generation system, comprising: an electrical power source of at least about 2,000 A/cur; a plurality of spaced-apart electrodes electrically connected to the electrical power source; a fuel loading region configured to receive fuel, wherein the plurality of electrodes surrounds the fuel loading region, and wherein the plurality of electrodes is configured to supply power to the fuel to ignite the fuel when received in the fuel loading region, and wherein a pressure in the fuel loading region is a partial vacuum: a delivery mechanism for moving the fuel into the fuel loading region; and a photovoltaic power converter configured to convert plasma generated from the ignition of the fuel into a non-plasma form of power.

Further embodiments are directed to a power generation cell, comprising: an outlet port coupled to a vacuum pump; a plurality of electrodes electrically coupled to an electrical power source of at least about 5,000 kW; a fuel loading region configured to receive a water-based fuel comprising a majority H2O, wherein the plurality of electrodes is configured to deliver power to the water-based fuel to produce at least one of arc plasma and thermal power, and a power converter configured to convert at least a portion of at least one of the arc plasma and the thermal power into electrical power. Also disclosed is a power generation system, comprising: an electrical power source of at least about 5,000 A/cm2: a plurality of electrodes electrically coupled to the electrical power source; a fuel loading region configured to receive a water-based fuel comprising a majority H2O, wherein the plurality of electrodes is configured to deliver power to the water-based fuel to produce at least one of arc plasma and thermal power; and a power converter configured to convert at least a portion of at least one of the arc plasma and the thermal power into electrical power, in an embodiment, the power converter comprises a photovoltaic converter of optical power into electricity.

Additional embodiments are directed to a method of generating power, comprising: loading fuel into a fuel loading region, wherein the fuel loading region includes a plurality of electrodes; applying a current of at least about 2,000 A/cm2: to the plurality of electrodes to ignite the fuel to produce at least one of arc plasma and thermal power; performing at least one of passing the arc plasma through a photovoltaic converter to generate electrical power; and passing the thermal power through a thermal-to-electric converter to generate electrical power, and outputting at least a portion of the generated electrical power. Also disclosed is a power generation system, comprising: an electrical power source of at least about 5,000 kW; a plurality of electrodes electrically coupled to the power source, wherein the plurality of electrodes is configured to deliver electrical power to a water-based fuel comprising a majority H2O to produce thermal power.

A heat exchanger configured to convert at least a portion of the thermal power into electrical power; and a photovoltaic power converter configured to convert at least a portion of the light into electrical power, in addition, another embodiment is directed to a power generation system, comprising: an electrical power source of at least about 5,000 kW; a plurality of spaced apart electrodes, wherein at least one of the plurality of electrodes includes a compression mechanism; a fuel loading region configured to receive a water-based fuel comprising a majority H2O, wherein the fuel loading region is surrounded by the plurality of electrodes so that the compression mechanism of the at least one electrode is oriented towards the fuel loading region, and wherein the plurality of electrodes are electrically connected to the electrical power source and configured to supply power to the water-based fuel received in the fuel loading region to ignite the fuel; a delivery mechanism for moving the water-based fuel into the fuel loading region; and a photovoltaic power converter configured to convert plasma generated from the ignition of the fuel into a non-plasma form of power.

Due to the continuous depletion of the world supply of fossil fuel and the continuous increase in fuel cost and pollution to the environment, alternative green sources of energy have been investigated for possible use in powering vehicles, such as automobiles, trucks, buses, trains, airplanes, etc. Alternative sources of energy have also been investigated to reduce pollution levels in cities and towns throughout the world; a significant portion of such pollution is generated by fossil fuels such as gas, diesel, etc., used in today's vehicles. Such investigations focus on electrically powered vehicles driven by at least one electric motor due to the non-polluting nature inherent with electrical motors and the ready supply of electricity to run the electric motors.

A permanent connection of the electric motor to electrical power supply lines is impossible due to the vehicles' mobility; that is, vehicles are not fixed at one location. Therefore, in an electrically powered vehicle, a set of batteries is mounted within the vehicle used as storage to supply the electricity needed to run the electric motor(s) and all other vehicle functions. In previously constructed electric vehicles, batteries are typically heavy and are required in large numbers to provide an adequate driving range between recharging periods. Batteries are recharged at the home, office, recharging stations, etc., by suitable power supply units. Therefore, such batteries still utilize electricity generated by conventional means such as fossil fuel, coal, hydro, nuclear, etc., with dire consequences to the environment.

Other designs used wind turbines to generate electricity to charge the batteries where these turbines are placed on the top of the vehicle. Such action ignores most of the vehicle's useful wind streams, especially the necessary right and left-side wind streams. Increases drag forces on the vehicle, hence reducing the adequate electric power generated from the wind turbine's generator. Additionally, the designs are not practical or even not safe for domestic use. Other types of electric vehicles use solar panels to generate electricity to recharge the batteries, and often-such designs are not successful for regular vehicles with many passengers driving on a typical highway due to the limited area and the low efficiency of the solar panels; hence, the limited electric power they generate. Most, if not all, of the previously proposed electric vehicles have limitations in driving range, driving speed, several passengers, and/or safety. Some electric vehicles depend directly or indirectly on fossil fuel, coal, hydro, nuclear, etc., with dire consequences on the environment.

Examples of prior art electric vehicles are found in several US patents. In Dykes U.S. Pat. No. 3,575,250 (1971), a two-wheeled vehicle with a quick-disconnect battery hung between the two wheels is connected to various wheeled devices, such as a supermarket cart, to provide an articulated assembly driven by the two-wheeled vehicle. Each wheel of the two-wheeled vehicle has its motor. The motors are series-connected at one setting and parallel connected at another, and “in turning, one of the motors will load and slow down and the other will speed up in a differential action to assist in the turning of the vehicle.”

In Adams U.S. Pat. No. 3,934,669 (1976), a two-wheeled, electric vehicle having an outer contour resembling a piece of luggage is proposed. An electrically powered motor mounted to the steering column provides the motive force for driving the steered wheel to propel the vehicle.

In Dow U.S. Pat. No. 3,190,387 (1965), a four-wheeled vehicle has two drive wheels, each provided with its motor carried on the vehicle frame, which is sprung on the wheels. The batteries are carried over the vehicle's rear axle but forwardly of the motors and on the sprung frame. In Hafer U.S. Pat. No. 3,708,028 (1973), an electric truck is provided with a battery pack that can be positioned and removed from the truck's side with a forklift truck.

In Ward U.S. Pat. No. 4,042,055 (1977), an electric vehicle can carry “two 180-pound riders and two 20 or 30-pound golf bags more than 40 holes on a moderately hilly golf course using four standard 62.5 pound 6-volt rechargeable batteries.”

In Maki et al. U.S. Pat. No. 3,960,090 (1976), an electric vehicle powered by a linear synchronous motor is proposed. “The linear synchronous motor comprises a series of field poles fitted on the vehicle body along its total length and a series of magnetic devices being provided along a track on the ground facing these field poles and developing a traveling magnetic field. A driving force developed between these field poles and the magnetic devices causes the vehicle to move.” External electrical current sources energize the magnetic devices on the truck. In Boudreaux U.S. Pat. No. 7,605,493 B1 (2009) proposes an electric vehicle powered by a generator and the generator driven by gasoline. This, in turn, will cause the same dire impacts on the environment produced by a regular fossil-fuel vehicle or alike.

In Richardson U.S. Pat. No. D374,656 (1996), an ornamental design for a car-top wind generator, is presented. This design is dangerous but deemed useless due to the enormous drag forces it generates, similarly, in Trumpy U.S. Pat. No. 4,282,944 (1981), a wind motor generator with three vanes mounted on the top of the vehicle is also presented in Amick U.S. Pat. No. 4,117,900 (1978) a passenger car deriving all or a part of its motive power from the wind through a system of one or more rigid vertical airfoils is presented in Bussiere U.S. Pat. No. 4,423,368 (1983) a turbine air battery charger is presented. Bussiere collects only a portion of the full wind steam ignoring all front and side winds surround the vehicle.

He divides one air stream into two outlets driving two wind turbines rather than combing the two outlets mechanically to drive only one turbine. As in Bussiere, Brierley U.K. Pat. No. GB2126963A (1982) proposed an air-powered electric vehicle, ignoring all side wind streams surrounding the vehicle.

In Kim U.S. Pat. No. 7,445,064 B2 (2008) a vehicle using wind force is presented, and a wind ventilator is placed externally on the top of the trunk. This design harnesses a small portion of the wind forces and ignores all right side and left side winds surrounding the vehicle. Kim uses maglev forces to rotate the generator shaft when the “winds does not blow” and to keep the generator operating and the batteries continuously charging. However, Kim fails to tell us how he is going to supply the required alternating electric current to the coils in the disk wall to change the polarity of the magnetized coils and generate the disk rotational movement. If Kim uses the same batteries that he wants to charge as the alternating current source, the design is deemed a failure.

Nevertheless, Kim states, “electric power charged through the solar heat charging plate 13 is stored in the charger 14 helps the rotary gear 32 to rotate, while driving the small-sized motor 40.” Kim does not clarify how he stores “electric power” in a “charger” to run a small motor or two small motors. Kim also does not explain how he converts “solar heat” to electricity. Additionally, depending on a “solar heat charging plate” to run a generator may be less reliable.

### PRIOR ART SEARCH

BR112018014674A2 *2016-01-192018-12-11 Brilliant Light Power Incpower supply system that generates at least one of electrical and thermal energy.
TW201826288A *2016-05-302018-07-16 Thermophotovoltaic electrical power generator network.
TWI577481B *2016-06-302017-04-11 The electrode holder of the air plasma cutting device.
TWI586969B *2016-08-152017-06-11 Application method of probe altitude for probe testing and cleaning equipment and the equipment thereof.
U.S. Ser. No. 10/732,378B2 *2017-01-252020-08-04 Flir Systems, Inc. Mounting optical elements in optical systems.
TWI680632B *2017-10-032019-12-21 Circuit structure of high power supply.
TWI655834B *2018-04-032019-04-01 Motor unit with rapid heat dissipation.
CN108844567A *2018-04-192018-11-20 A kind of full tungsten is towards plasma sample stage.
CN108933502B *2018-09-112020-04-10 Virtual synchronous power generation system.
U.S. Ser. No. 10/731,557B12019-04-192020-08-04 Hamilton Sundstrand Corporation Cyclonic dirt separator for high efficiency Brayton cycle based micro turbo alternator.
U.S. Pat. No. 3,190,387A *1962-08-101965-06-22 Dow Douglas Electric drive mechanism and method of operating same.
U.S. Pat. No. 3,374,849A *1966-09-281968-03-26 Lawrence E. Redman Electric vehicle.
U.S. Pat. No. 3,477,537A *1967-12-191969-11-11 Paul J Plishner Electric motor-driven automobile.
U.S. Pat. No. 3,556,239A *1968-09-231971-01-19 Joseph W Spahn Electrically driven vehicle
U.S. Pat. No. 3,659,672A *1971-01-111972-05-02 Charles J Jacobus Control system.
U.S. Pat. No. 3,708,028A *1970-12-211973-01-02 Boyertown Auto Body Works Electrically driven vehicles.
U.S. Pat. No. 3,713,504A *1971-05-261973-01-30 Gen Motors Corp Vehicle electric drive providing regulation of drive wheel operating speed difference.
U.S. Pat. No. 3,870,935A *1971-08-061975-03-11 Linde Ag Vehicle drive with two electric motors.
U.S. Pat. No. 3,934,669A *1974-08-261976-01-27 Adams Herbert L Powered vehicle
U.S. Pat. No. 3,960,090A *1973-08-151976-06-01 Hitachi, Ltd. Linear synchronous motor powered vehicle.

### OBJECTIVES OF THE INVENTION

Electric car, which should generate the car fuel energy from the Sun with Positive and Negative Signals, can run the vehicle. The Car should be Autonomic which should fly in the Air and Space and lock the position of the Car in certain heights and drive along the way and which should be completely automated. The Car should have the below features

1. The objective of the invention is to a Full Control overturns wheel propeller and creates eject
2. The other objective of the invention is to add any add-on in terms of Software Upgrades Easily
3. The other objective of the invention is Traffic management
4. The other objective of the invention is to the Car should have the ability to demonstrate detection for collision
5. The other objective of the invention is to Work in the Space net network.
6. The other objective of the invention is to work with AI and Neural network-based models Fully
7. The other objective of the invention is to Early change the Shape of the Car with various colors and design
8. The other objective of the invention is to It should work with Neural network brain signals.
9. The other objective of the invention is the ability to support Deep learning training.

### SUMMARY OF THE INVENTION

A solid or liquid fuel to plasma to electricity power source that provides at least; one of electrical and thermal power comprising.

(i) At least one reaction cell for the catalysis of atomic hydrogen to form hydrinos, (ii) a chemical feel mixture comprising at least two components chosen from: a source of H₂O catalyst or H₂O catalyst; a source of atomic hydrogen or atomic hydrogen; reactants to form the source of H₂O catalyst or H₂O catalyst and a source of atomic hydrogen or atomic hydrogen; one or more reactants to initiate the catalysis of atomic hydrogen; and a material to cause the feel to be highly conductive,
(iii) A fuel injection system such as a railgun shot injector,
(iv) At least one set of electrodes that confine the fuel and an electrical power source that provides repetitive short bursts of low-voltage, high-current electrical energy to initiate rapid kinetics of the hydrino reaction and an energy gain due to forming hydrinos to torn! a brilliant-light emitting plasma,
(v) A product recovery system such as at least one of an augmented plasma railgun recovery system and a gravity recovery system.
(vi) A fuel pelletizer or shot maker comprising a s me Her. a source or hydrogen and a source of H₂O, a dripper and a water bath to form fuel pellets or shot, and an agitator to teed shot into the injector, and
(vii) a power converter capable of converting the high-power light output of the cell into electricity such as a concentrated solar power device comprising a plurality of ultraviolet (UV) photoelectric cells or a plurality of photoelectric cells, and a UV window.

Perspective on the previous disservices intrinsic in the known sorts of Fuel-Free Electric Vehicles currently present in the earlier workmanship, the current development gives another Solar and Wind Powered, Perpetual, Fuel-Free Electric Vehicle; wherein the equivalent can be used for giving a dependable electric vehicle equipped for being utilized by one or numerous travelers at typical rates in urban areas and towns, and on expressways and byways, and in whatever may happen.

There is uncovered in this an attractive sun based and wind controlled electric vehicle using electrical force changed over from both episode sun-powered radiation and wind stream encompassing the vehicle. The solar radiation is converted by solar panels comprising a series of photovoltaic (PV) cells arranged in a thin layer on every and the all-available surface of the vehicle exterior to capture the maximum amount of solar radiation. As commonly known, PV cells are made of semiconductor materials, for example, silicon and amalgams of indium, gallium, and nitrogen. As the individual cells' interconnection is notable and isn't pertinent to the current creation, subtleties of such interconnection won't be portrayed thus. It will be seen, in any case, that such individual PV cells are interconnected to give through a typical yield link a consistent progression of electric energy. Such electrical energy is applied by a solar charger unit 42 to a controller unit 50 to charge the battery array 48 of the electric vehicle 10.

The wind streams surrounding the vehicle at the front of the vehicle, the top of the vehicle, the left side, and the vehicle's right side are harnessed by air inlets and passed through by funnel-like air ducts into one or more wind turbines. To collect the maximum amount of wind streams and to accelerate the collected winds, each funnel-like air duct has the largest cross-section area at the vehicle surface to collect the maximum amount of the prospective wind stream, and the smallest cross-section area of the air duct is directed to the wind turbine system. The higher the level of streamlined wind achieved and the smaller the cross-sectional area of the air duct at the wind turbine system's entry, the greater the streamlined wind and the higher will be its velocity on entry into the wind turbine system; hence, the maximum generated electricity. Each wind turbine system comprises:

(1) Rotor blades to capture wind energy;
(2) A shaft to transfer rotational energy to an electric generator
(3) nacelle casing that holds (a) a gearbox to increase the speed of shaft between rotor hub and electric generator; (b) an electric generator to convert rotational energy into electricity; (c) an electronic controller to monitor system, move the rotor to align with the direction of winds as known as yaw mechanism control, and shut system in case of malfunction; and (d) brakes to stop shaft rotation in case of overload and or system failure. Details of such a device will not be mentioned here, as the wind turbine system is well known and is not Germanic to the present invention. However, it can be understood that such an individual wind turbine device is built to provide a continuous flow of electric energy through a standard output cable. Such electrical energy is applied by a wind regulator unit 44 to a controller unit 50 to charge the battery array 48 of the electric vehicle 10.

### BRIEF DESCRIPTION OF THE DIAGRAM

FIG. 1: is a perspective view of a solar and wind powered, magnet electric vehicle.

FIG. 2: is a schematic view of the funnel-like air ducts in the electric vehicle of FIG. 1.

FIG. 3: is perspective view of an alternative embodiment of the invention, showing two wind turbine systems.

FIG. 4: is a schematic view of the funnel-like air ducts in the electric vehicle of FIG. 3.

FIG. 5: is: a schematic block diagram of the electrical system utilized in the solar and wind powered electric vehicle.

### DESCRIPTION OF THE INVENTION

FIG. 1 through FIG. 5 thereof, a new Perpetual, Fuel-Free Electric Vehicles shall be defined as embodying the principles and concepts of the present invention and as generally stated by reference number 10.

Alluding to FIG. 1 through FIG. 5, a sun-oriented and wind-fueled vehicle 10 built as per the standards and ideas of the current development. The sun based and wind controlled vehicle 10 is a traditional electrically fueled vehicle having at any rate one electric engine 34 mounted in that which is associated with the vehicle transmission and driving the train for impelling the vehicle. The electric motor 34 receives electrical power from the controller unit 50, and the controller unit 50 gets its power from an array of rechargeable batteries 48. The controller unit 50 controls the electric motor's speed using a closed-loop feedback control system. The driver presses an accelerator pedal 36 to control the speed of the vehicle 10; the voltage signal from the potentiometer 38 changes accordingly. The voltage signal from the potentiometer 38 tells the controller how much power to deliver to the electric Car's motor. Further, there would be a 12-volt accessory battery 40 for powering the standard electrical components and other vehicle functions, namely the lights, radio, horn, fan, heater, defogger, and other units. The provided 12-volt accessory battery 40 is continuously charged from the battery array 48 by a DC-DC voltage converter/charger, not shown, built within the controller unit 50.

With reference now to FIG. 1, the primary embodiment of the present invention, the vehicle 10 is provided with a plurality of solar panels 12 and a wind turbine system 14 to harness solar, wind energies and convert them to electrical energy. The solar panels 12 are electrically connected to a solar charger 42, which is electrically connected to the controller unit 50, which supplies electrical current to recharge the battery array 48. Referring to FIG. 1 and FIG. 2, vehicle 10 is provided with front wind inlet 16, top wind inlet 18, right-side wind inlet 20, and left-side wind inlet 21. Each wind inlet is connected to a funnel-like air duct 28 where the largest cross-section area of the air duct 28 at the vehicle surface to collect the maximum amount of the prospective wind stream and the smallest cross-section area of the air duct 28 is at the entry of the wind turbine system 14. As shown in FIG. 2, the air ducts 28 of the top wind inlet 18 extend along two sides of the fender wall then connect mechanically with all other air ducts 28 at a point before the wind turbine system 14 and the streamlined winds from all air ducts are applied collectively to the blades of the wind turbine system 14. The wind turbine system generator's generated electrical energy, not shown, is applied to the wind charger 44, which is electrically connected to the controller unit 50, which supplies electrical current to that for recharging the battery array 48.

FIG. 3 and FIG. 4 show an alternative embodiment of the invention, in which solar panels 12 and two wind turbine systems are provided. Front wind turbine system 30 and rear wind turbine system 32 are provided to generate more electrical energy than the basic embodiment shown in FIG. 1. The front winds passing through the front wind inlet 16 drives the front wind turbine system 30. The streamed winds from the side wind inlets 20 and 21 and the top wind inlet 18 combined to drive the rear wind turbine system 32. The electrical outputs of the generators of both the front wind turbine system 30 and the rear wind turbine system 32 are applied to the wind charger 44, which is electrically connected to the controller unit 50, which supply electrical current to that for recharging the battery array 48. Other alternative embodiments of the invention, in which three or more wind turbine systems at different locations and two or more electric motors can be easily presented. In case of a system failure or unexpected emergency, the storage battery array 48 may be recharged by a conventional power supply unit 46 to connect to a suitable source of electrical energy, such as an electrical outlet within a building or residential home. As to a further discussion of the manner of usage and operation of the present invention, the same should be apparent from the above description. Accordingly, no further discussion relating to the manner of usage and operation will be provided.

While the concepts of that invention about specific equipment have been defined above, it must be clearly understood that that definition is rendered purely by illustration and not as a restriction to the scope of the invention. As far as the above definition is concerned, then, it must be understood that the optimum dimensional relationships for the parts of the invention, including variations in size, materials, form, shape, function, and mode of operation, assembly, and usage, are considered to be readily apparent and apparent to one expert in the art and all the identical relationships with those illustrated in the drawings and described in the drawings. The above is therefore deemed to be illustrative only of the ideals of the invention. Furthermore, since numerous modifications and modifications are readily available to those skilled in the art, it is not desirable to restrict the invention to the precise construction and operation shown and defined. All acceptable modifications and equivalents falling within the scope of the invention may be applied accordingly. Therefore, the scope of the invention should be defined by the arguments in the appendix and their legal equivalents, not by the examples given.

1. An “Automatic Fuel Energy Generated Car” method to generate adequate electrical power to charge a plurality of storage batteries driving a perpetual, fuel-free electric vehicle or alike, wherein the batteries supply adequate power to at least one electric motor to propel the vehicle and supply electricity to all other vehicle instruments such as lights, wipers, defogger, etc,
wherein two alternatives, and green energy sources are used to continuously charge the batteries: solar energy generated from solar panels covering every and all possible area of the vehicle's exterior surface and wind energy generated by one or more electric generators driven by one or more wind turbines mounted within the vehicle and placed under its exterior surface;
wherein a front, top and side wind streams surrounding the vehicle, are channeled through air passages and each air passage is designed as a funnel-like air duct where the end of the air duct with the smaller cross-sectional area is directed into the entry of the wind turbine system to accelerate the streamlined winds, the energy of the aggregated and accelerated winds is harnessed by one or more wind turbine systems placed in the wind streams' path, each wind turbine system has an electric generator to convert the turbine shaft's rotational energy into electric energy;
wherein the output of each wind turbine generator is applied to a controller unit where electric voltage is regulated and converted, if necessary, to charge the plurality of storage batteries, the outputs of the solar panels are also applied to the controller unit to be regulated and converted if necessary to charge storage batteries' plurality;
wherein the controller unit continuously charges the electric vehicle's batteries, whether the vehicle is stopped or running, the controller unit is also connected to an external, stand-by power supply unit used only to charge the batteries under unexpected circumstances such as system failure.

2. The method according to claim 1, wherein the method is used to generate adequate electrical power to charge a plurality of storage batteries driving a perpetual, fuel-free electric vehicle or alike.

3. The method according to claim 1, wherein the method is to supply adequate power to at least one electric motor to propel the vehicle and supply electricity to all other vehicle instruments such as lights, wipers, defogger, etc.

4. The method according to claim 1, wherein two alternatives, and green energy sources are used to continuously charge the batteries: solar energy generated from solar panels covering every and all possible area of the vehicle's exterior surface and wind energy generated by one or more electric generators driven by one or more wind turbines mounted within the vehicle and placed under its exterior surface.

5. The method according to claim 1, wherein a front, top and side wind streams, surrounding the vehicle, are channeled through air passages and each air passage is designed as a funnel-like air duct where the end of the air duct with the smaller cross-sectional area is directed into the entry of the wind turbine system to accelerate the streamlined winds.

6. The method according to claim 1, wherein the energy of the aggregated and accelerated winds is harnessed by one or more wind turbine systems placed in the path of the wind streams, and each wind turbine system has an electric generator to convert the rotational energy of the turbine's shaft into electric energy.

7. The method according to claim 1, wherein the output of each wind turbine generator is applied to a controller unit where electric voltage is regulated and converted, if necessary, to charge the plurality of storage batteries.

8. The method according to claim 1, wherein the outputs of the solar panels are also applied to the controller unit to be regulated and converted if necessary to charge the plurality of storage batteries.

9. The method according to claim 1, wherein the controller unit continuously charging the electric vehicle's batteries, whether the vehicle is stopped or running, and wherein the controller unit is also connected to an external, stand-by power supply unit used only to charge the batteries under unexpected circumstances such as system failure.
